(19) United States
(12) Patent Application Publication
(10) Pub. No.: US 2005/0089670 A1
(43) Pub. Date: Apr. 28, 2005

(54) Casting preforms for optical fibres

(76) Inventors: Maryanne Candida Jane Large, West Pymble (AU); Joseph Zagari, Condell Park (AU); John Canning, Carlton (AU); Tom Ryan, Chippendale (AU); Martin Alexander van Eijkelenborg, Newtown (AU); Nilmini Sureka Goringe, Seven Hills (AU); Nader Issa, Newtown (AU)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/484,219

(22) PCT Filed: Jul. 22, 2002
(86) PCT No.: PCT/AU02/00976

(30) Foreign Application Priority Data
Jul. 20, 2001 (AU) PR 6496

(51) Int. Cl. B29D 11/00; B29C 33/58; B29C 33/76

(52) U.S. Cl. 428/131; 264/154; 264/1.24; 264/338; 264/317; 264/314

(57) ABSTRACT

This invention relates to a method of preparing a preform for an optical fibre, and more particularly to a method of preparing a preform for a polymer holey optical fibre. The invention provides a method of preparing a preform for manufacture of a polymer holey optical fibre comprising casting a preform body in a mould from a suitable material, said mould including at least one protrusion adapted to form a corresponding hole within the preform, and subsequently separating the preform body and mould. The invention also provides a method of preparing a preform for manufacture of a polymeric holey optical fibre comprising separately casting one or more elements of a preform in respective mould(s) from a suitable material, and separating said elements from said respective mould(s) and combining said elements to construct a preform having a plurality of holes therein, each hole being formed in an element or formed by the combination of two or more elements.

### FIELD OF THE INVENTION

This invention relates to a method of preparing a preform for an optical fibre, and more particularly to a method of preparing a preform for a polymer holey optical fibre.

### BACKGROUND TO TH INVENTION

Any discussion of the prior art throughout the specification should in no way be considered as an admission that such prior art is widely known or forms part of common general knowledge in the field.

In the late 1990's, Philip Russell from the University of Bath, United Kingdom and his co-workers developed optical fibres which comprised micro structured silica with a series of several hundred air holes running along its length.

These fibres were sometimes referred to as holey fibres and more lately as crystal fibres due to the complex lattice microstructure of the air holes. Technically, such holey or crystal fibres do not include a “core” or “cladding” as the terms are used when referring to conventional graded index optical fibres. In the art, however, the term “cladding” is sometimes used to refer to the microstructure or lattice of air holes, of the “core” being a reference to the defect or irregularity in this microstructure lattice, ie. absence of an air hole through which the fibre transmits light. The first generation of fibres used a simple repeating triangular arrangement of air holes, with a single missing air hole forming the defect through which light was transmitted. More complex structures have now been developed.

Originally, Russell and his team developed the fibres to exploit photonic band gap effect. However, it was soon realised that the fibres also operated by simple index guidance due to the high refractive index of the core region or defect compared to the effective index of the surrounding air holes or cladding microstructure.

While the performance of crystal fibres via index guiding is well known, their use for transmission via the photonic band gap effect is not as well known. In particular, the size, shape and layout of the air holes must be strictly controlled to first realise and enhance transmission by photonic band gap.

Accordingly, it would be useful to have an improved production method for producing optical fibre which not only provides consistent results but which allows more varied arrangement of the fibre.

It is an object of the present invention to overcome or ameliorate at least one of the disadvantages of the prior art, or to provide a useful alternative.

### SUMMARY OF THE INVENTION

To this end one aspect of the present invention provides a method of preparing a preform for manufacture of a polymeric holey optical fibre comprising casting a preform body in a mould from a suitable material, said mould including a plurality of protrusions adapted to form a corresponding plurality of holes within the preform, and subsequently separating the preform body and mould.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

A further aspect of the present invention provides a method of preparing a preform for manufacture of a polymeric holey optical fibre comprising separately casting a plurality of elements of a preform in respective mould(s) from a suitable material, and separating said elements from said respective mould(s) and combining said elements to construct a preform having a plurality of holes therein, each bole being formed in an element or formed by the combination of two or more elements.

A further aspect of the present invention provides a preform for manufacture of a polymeric holey optical fibre comprising a preform body cast from a suitable material, said preform body including a plurality of holes.

A further aspect of the present invention provides a preform for manufacture of a polymeric holey optical fibre comprising a plurality of elements cast from a suitable material, said elements being combined to construct a preform having a plurality of holes therein, each hole being formed in an element or formed by the combination of two or more elements.

Typically, the material from which the preform is cast comprises a suitable monomeric or mixed polymeric/monomeric material.

Preferably, the holes in the preform pass through the preform.

Preferably, the holes have parallel axes and are parallel to the principal axis of the preform.

Advantageously, the present invention allows the casting of preforms, capillaries and canes for photonic crystal fibres. The casting method of the present invention can be used to produce the preform as a unitary body, or as a series of separate interconnectable elements.

The preform can be separated from the mould as a unitary body for later drawing into a fibre. Alternatively, in some cases it may be preferable to draw the optical fibre directly from the preform while it remains in the mould.

The above described technique and its preferred embodiments provides a number of significant advantages over the prior art. They include the opportunity to produce holey fibre preforms with discrete elements, eg. air holes, of various shapes and sizes, complex fibre shapes which are currently difficult or expensive to produce using conventional techniques, eg. multiple core structures, ability to produce holey fibres from a wide range of optically suitable materials than is currently used, a more efficient mechanism for producing holey optical fibres and preforms, and the opportunity to provide continuous production of such products.

### BRIEF DESCRIPTION OF THE DRAWINGS

A preferred embodiment of the invention will now be described, by way of example only, with reference to

FIG. 1 which illustrates a section of a preform with interstitial holes formed from adjacent canes.

### DETAILED DESCRIPTION OF PREFERRED EMBODIMENT(S)

A number of preferred aspects of the invention will now be described, by way of example only.

This invention provides a method of producing structured polymer preforms, capillaries or canes suitable for subsequent drawing to form a holey polymer fibre. The entire preform may be cast as a unitary body, or canes and capillaries may be individually cast and combined to produce a polymer preform.

The possibility of casting preforms allows an almost limitless variety of structures to be produced. These may be either a complete preform for photonic crystal fibre, or canes or capillaries that allow such a preform to be constructed.

A key issue to be addressed in casting or moulding a holey structure in polymers is that polymers are generally more dense than their corresponding monomeric solutions. This means that in general, although not in every case, shrinkage of the order of 4-8% occurs during polymerisation. This has the result of shrinking the resulting polymer form within the mould. This poses a particular difficulty when moulding around a rod, as the rod will tend to become trapped in the polymer. There are, however, a number of possible solutions to this problem, including:
(i) Mismatching the thermal expansion coefficients of the mould and the polymer so that heating or cooling causes the effective shrinkage of the mould relative to the polymer.
(ii) Using sacrificial moulds For example, the moulds may dissolve or melt.
(iii) Using sacrificial coatings.
(iv) Using relatively “soft” moulds or coatings.
(v) Using “inflatable” moulds.
(vi) Coating or forming the mould surfaces with a material such as Teflon so as to reduce adhesion.
(vii) Heating the mould so that there is localised softening or melting of the polymer thereby allowing the rod to be removed.
(viii) Designing the cast structure in such a way that the holes are effectively interstitial holes, so that the opportunity for rods to become trapped is removed
(iv) Using lubricant(s).
(x) Using memory metals.
(xi) Using tapered polished rods.

It is to be noted that some of the above techniques may be used in combination to produce the preform. For example, low adhesion coatings may be used in many of the moulding techniques specified above. These techniques are discussed in further detail below.

(i) Mismatching Thermal Expansion Coefficients of Mould and Polymer

The thermal expansion coefficients of the mould and polymer are such that heating the combined mould and polymer causes the mould and the polymer to expand by different amounts. This effect can be made to allow the removal of the mould by one of two mechanisms. If the polymer expands by more than the mould then the mould can be removed while the structure is at an elevated temperature. If the mould expands by more than the polymer the effect can be used to put pressure on the hot polymer around the mould, distorting it in a uniform way around the mould. If the structure is cooled appropriately, this distortion will remain in place when the structure is cooled, allowing the rod to be removed.

(ii) Using Sacrificial Moulds

Sacrificial moulding techniques may be employed in order to remove the mould material after the casting of the preform has occurred.

For example, after casting the body of the preform the mould is not removed intact after casting, but is liquefied and removed in the liquid state. This is either done by dissolving the mould, or by melting it. There are a large number of solvents available that will dissolve a chosen mould material but not the polymer, the choice depending upon the polymer used. It should be noted however that the process of dissolving the mould may be slow if the holes required are very small.

Alternatively, the mould could be liquefied by melting, provided that the melting point of the mould material is below the glass transition temperature of the polymer and the polymerisation is “cold”. The temperature during polymerisation should not be allowed to rise above a point at which the mould softens. An example is a polymer such as PMMA with a glass transition temperature of around 100° C., and a mould made of wax which has a melting point of 50°-60° C. It is to be noted that the polymerisation of PMMA is exothermic, and therefore this would need to be controlled in order to prevent the mould from being melted before desired.

One shortcoming of this approach is that the mould is destroyed in each case. However if the mould is cast, or assembled from standard rods then this may be alleviated. The use of a sacrificial coatings, discussed below, would also alleviate this problem.

In addition a cleaning step may be required to remove residual mould material. This may include dissolving any melted material that may remain, solvent washing with sonication etc.

A further example is the use of moulds comprising a particulate material and a binder, wherein the binder may be dissolved or melted upon the completion of the casting process so as to facilitate destruction of the mould and the removal of the casted preform.

(iii) Using Sacrificial Coatings

As an alternative to using sacrificial moulds, it is conceivable to use moulds to which a sacrificial surface coating is applied in order to facilitate the separation of the mould and the preform after casting has occurred.

(iv) Using Relatively “Soft” Moulds or Coatings

A further alternative would be to use moulds formed from relatively soft, deformable material, or alternatively, moulds which have a surface coating of relatively soft, deformable material which shrink or contract. An example of such a material is Teflon™.

(v) Using “Inflatable” Moulds

In this case, the mould is inflated by means of a liquid or gas whilst casting occurs and subsequently deflated upon completion of the casting process so as to facilitate the removal of the casting from the mould.

(vi) Coated or Low Adhesion Moulds

The problem of adhesion of the polymer as it shrinks around the mould may be addressed by coating the mould with low stick material such as Teflon™ (PTFE) or by making the mould of such material.

If coating is used then care must be taken however that residual coating material does not remain inside the hole structure, requiring a cleaning process similar to that described in the section above.

It likely that in many cases the reduction in adhesion will not be sufficient to remove the mould, and the coating or low adhesion material approach would have be used in combination with one of the other techniques described here.

(vii) Heating the Mould

Heating the mould is another approach to the problem of adhesion and shrinkage of the polymer around the mould. Heating the mould will cause the material directly in contact with the mould surface(s) to heat and soften, enabling the withdrawal of the rods of the mould. Heating could be applied by a number if means, for example if the rods are made of metal and the preform material is resistive, a current could be passed through the rods to heat them. One potential disadvantage of this approach is that the internal surface of the hole may become damaged.

(viii) Interstitial Hole Mould Designs

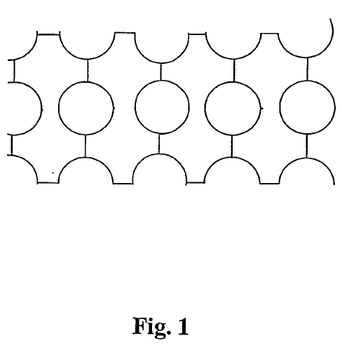

The major difficulty with casting holey structures is that of shrinkage around the rods required in the mould to produce the structure. However, by stacking solid canes of appropriate design it possible to produce interstitial holes of a suitable geometry, without ever needing to cast a voided structure. Such solid structures could easily be removed from their moulds, provided that the surfaces were chosen such that they did not adhere. The solid structures could also have a tongue-groove structure that allowed them to locate correctly with respect to others in the stack. The solid canes would then have to be fused to product a holey structure. An example of this design concept is illustrated in FIG. 1.

(ix) Using Lubricant(s)

In certain applications, it is possible to use lubricant to reduce the adhesion between the mould and the body of the cast preform so as to facilitate separation upon completion of the casting process.

(x) Using Memory Metals

Shape memory metals are metal materials which change their form upon the application of heat and it is envisaged that such metals could be used in the mould(s) so as to facilitate separation of the mould from the body of the cast preform upon the completion of the casting process. One such example of a shape memory alloy is an alloy of nickel and titanium (commonly referred to as NiTinol) which may be used to form a rod around which the body of a preform is cast. After casting, the rod of shape memory alloy can be cooled, resulting in a contraction in its shape and facilitating its removal from the surrounding cast body.

(xi) Using Tapered Polished Rods

In a further development, the rods which form the holes may be provided with a suitable taper to facilitate their withdrawal from the moulded body. The exterior surface of the rods may be highly polished in order to reduce adhesion.

Advantageously, the technique of casting polymer preforms for photonic crystal fibres allows novel preform structures to be produced easily, many of which could riot be easily made by other techniques.

It should be noted that as an alternative to casting it is conceivable that the techniques outlined above could also be employed to either extrude or injection mould the elements forming the preform body.

Although the invention has been described with reference to specific examples it will be appreciated by those skilled in the art that the invention may be embodied in many other forms.

1. A method of preparing a preform for manufacture of a polymeric holey optical fibre comprising casting a preform body in a mould from a suitable material, said mould including a plurality of protrusions adapted to form a corresponding plurality of holes within the preform, and subsequently separating the preform body and mould.

2. A method of preparing a preform for manufacture of a polymeric holey optical fibre comprising separately casting a plurality of elements of a preform in respective mould(s) from a suitable material, and separating said elements from said respective mould(s) and combining said elements to construct a preform having a plurality of holes therein, each hole being formed in an element or formed by the combination of two or more elements.

3. The method as claimed in claim 1 or 2, wherein the material from which the preform is cast comprises a suitable monomeric or mixed polymeric/monomeric material.

4. The method as claimed in any one of claims 1 to 3, wherein the said plurality of holes in the preform pass through the preform.

5. The method as claimed in any one of claims 1 to 4, wherein the said plurality of holes have parallel axes and are parallel to the principal axis of the preform.

6. The method as claimed in any one of claims 1 to 5, wherein the thermal expansion coefficients of the mould and the polymer are sufficiently different so that heating or cooling causes dimensional changes in the mould relative to the polymer to facilitate removal of the preform from the mould.

7. The method as claimed in any one of claims 1 to 6, wherein said mould is a sacrificial mould.

8. The method as claimed in any one of claims 1 to 7, wherein one or more surfaces of the mould are provided with a sacrificial surface coating in order to facilitate the separation of the mould from the body of the cast preform upon completion of the casting process.

9. The method as claimed in any one of claims 1 to 6, wherein one or more surfaces of said mould are coated with an adhesion reducing material in order to facilitate the separation of the mould and the preform after casting has occurred.

10. The method as claimed in claim 9, wherein said adhesion reducing material is PTFE.

11. The method as claimed in any one of claims 1 to 10, wherein the mould is heated to facilitate removal of the body from the mould.

12. The method as claimed in claim 7 wherein after casting the mould is liquefied and removed in a liquid state.

13. The method as claimed in claim 7 wherein a solvent is used to dissolve the mould after casting is complete.

14. The method as claimed in claim 7 wherein the mould comprises a particulate material and a binder that is dissolved or melted upon the completion of the casting process so as to facilitate destruction of the mould and the removal of the casted preform.

15. The method as claimed in any one of claims 1 to 5 wherein the mould is inflated by means of a liquid or gas whilst casting occurs and subsequently deflated upon completion of the casting process so as to facilitate the removal of the casting from the mould.

16. The method as claimed in any one of claims 1 to 5 wherein lubricant is used to reduce the adhesion between the mould and the body of the cast preform so as to facilitate separation upon completion of the casting process.

17. The method as claimed in claim 1 or 2 wherein the mould is formed from a shape memory metal so as to facilitate separation of the mould from the body of the cast preform upon the completion of the casting process.

18. The method as claimed in claim 16 wherein the shape memory alloy is an alloy of nickel and titanium which is used to form a rod around which the body of a preform is cast, such that after casting the rod of shape memory alloy is cooled, resulting in a contraction in its shape and facilitating its removal from the surrounding cast body.

19. A preform for manufacture of a polymeric holey optical fibre comprising a preform body cast from a suitable material, said preform body including a plurality of holes.

20. A preform for manufacture of a polymeric holey optical fibre comprising a plurality of elements cast from a suitable material, said elements being combined to construct a preform having a plurality of holes therein, each hole being formed in an element or formed by the combination of two or more elements.

21. A preform as claimed in claim 19 or 20 wherein the material from which the preform is cast comprises a monomeric or mixed polymeric/monomeric material.

22. A preform as claimed in any one of claims 19 to 21 wherein the said plurality of holes in the preform pass through the preform.

23. A preform as claimed in any one of claims 19 to 22 wherein the said plurality of holes have parallel axes and are parallel to the principal axis of the preform.
